(19) United States
(12) Patent Application Publication
(10) Pub. No.: US 2026/0195536 A1
(43) Pub. Date: Jul. 9, 2026

(54) GENERATING COHERENT EXTRACTIVE SUMMARIES BY TRAINING LLMS ON FEEDBACK ANNOTATIONS FROM INITIALLY GENERATED SUMMARIES

(71) Applicant: Adobe Inc., San Jose, CA (US)

(72) Inventors: Mihir Parmar, Tempe, AZ (US); Trung Bui, San Jose, CA (US); Seunghyun Yoon, Seoul (KR); Ryan A Rossi, Santa Clara, CA (US); Hanieh Deilamsalehy, Seattle, WA (US); Franck Dernoncourt, Seattle, WA (US)

(21) Appl. No.: 19/011,874

(22) Filed: Jan. 7, 2025

(51) Int. Cl. G06F 40/30

(52) U.S. Cl. CPC G06F 40/30

(57) ABSTRACT

The present disclosure relates to systems, non-transitory computer-readable media, and methods for training a large language model to generate coherent extractive summaries. In some embodiments, the disclosed systems generate an initial extractive summary of a digital document utilizing a large language model. In some embodiments, the disclosed systems generate a feedback set including a set of annotations indicating corrections to the initial extractive summary relative to one or more coherent summaries of the digital document and a set of quality scores for the initial extractive summary. In some embodiments, the disclosed systems adjust parameters of the large language model to reduce differences between the initial extractive summary and the one or more coherent summaries based on the feedback set.

### BACKGROUND

Recent years have seen improvements in hardware and software platforms for natural language processing such as generating document summaries of digital documents. Specifically, the capabilities of large language models (“LLMs”) have led to their integration into various artificial intelligence (“AI”) assisted summarization methods. In particular, some AI assisted summarization methods involve using LLMs to summarize a digital document by performing extractive summary, which involves extracting meaningful phrases and sentences from document text to summarize the document. However, due to the variety and complexity of content and structure of digital documents, utilizing LLMs to determine meaningful phrases and sentences during extractive summarization for providing coherent, diverse content while maintaining a faithful representation of the digital documents presents challenges in generating coherent summaries. Existing systems exhibit a number of drawbacks or disadvantages in generating coherent extractive summaries.

### SUMMARY

This disclosure describes one or more embodiments of systems, methods, and non-transitory computer readable media that solve one or more of the foregoing or other problems in the art by training an LLM to improve its ability to generate extractive summaries by conditioning the LLM on a feedback set that incorporates natural language annotations. For example, the disclosed systems generate an initial extractive summary of a digital document using an LLM. In one or more embodiments, the disclosed systems generate a feedback set annotating, scoring, and presenting a coherent extractive summary along with natural language feedback on how to improve the initial extractive summary to make it coherent. Additionally, the disclosed systems use the feedback set to train the LLM to produce coherent extractive summaries according to one or more training methods. In one or more embodiments, the disclosed systems condition the LLM based on the feedback set referencing one or more coherent summaries of the digital document in relation to the initial extractive summary. In one or more embodiments, the disclosed systems implement a pre-finetuning step that conditions the LLM to generate feedback, facilitating its supervised finetuning.

### BRIEF DESCRIPTION OF THE DRAWINGS

The disclosure describes one or more embodiments of the invention with additional specificity and detail by referencing the accompanying figures. The following paragraphs briefly describe those figures, in which:

FIG. 1 illustrates a diagram of an environment in which a generative extractive summary system operates in accordance with one or more embodiments.

FIG. 2 illustrates a diagram of an overview of the generative extractive summary system conditioning a large language model based on an initial extractive summary and a feedback set in accordance with one or more embodiments.

FIGS. 3 illustrates a diagram of conditioning the large language model by using a finetuned approach in accordance with one or more embodiments.

FIG. 4 illustrates a diagram of conditioning the large language model by using a pre-finetuned approach in accordance with one or more embodiments.

FIG. 5 illustrates a diagram of utilizing one or more annotation sources to generate one or more feedback sets in accordance with one or more embodiments.

FIG. 6 illustrates a prompt for generating a coherent summary in accordance with one or more embodiments.

FIG. 7 illustrates an example feedback set in accordance with one or more embodiments.

FIG. 8 illustrates a diagram of generating one or more quality scores in accordance with one or more embodiments.

FIGS. 9A-9B illustrate experimental result data for the generative extractive summary system in accordance with one or more embodiments.

FIG. 10 illustrates an example schematic diagram of a generative extractive summary system in accordance with one or more embodiments.

FIG. 11 illustrates an example flowchart of a series of acts for adjusting parameters for a large language model from an initial extractive summary and a feedback set in accordance with one or more embodiments.

FIG. 12 illustrates a block diagram of an example computing device in accordance with one or more embodiments.

### DETAILED DESCRIPTION

This disclosure describes one or more embodiments of a generative extractive summary system that generates extractive summaries of digital documents by conditioning an LLM to generate coherent extractive summaries on natural language feedback. For example, the generative extractive summary system utilizes an LLM to generate an initial extractive summary for a digital document according to an extractive prompt. In one or more embodiments, the generative extractive summary system generates a feedback set corresponding to the initial extractive summary (e.g., with natural language corrections for the initial extractive summary). Additionally, the generative extractive summary system utilizes the feedback set to train the LLM to generate improved extractive summaries based on the natural language corrections.

As mentioned, in one or more embodiments, the generative extractive summary system generates a feedback set for an initial extractive summary generated by an LLM. In one or more embodiments, the generative extractive summary system determines the feedback set including one or more of a set of annotations indicating corrections for the initial extractive summary in relation to one or more coherent summaries of the digital document. For example, the generative extractive summary system determines natural language annotations provided by a number of annotation sources (e.g., users and/or machine-learning models) to generate feedback sets. In one or more embodiments, the generative extractive summary system also determines the feedback set including a set of quality scores for the initial extractive summary. To illustrate, the generative extractive summary system determines quality scores indicating relevance, coherence, and consistency of the initial extractive summary for inclusion in the feedback set.

In one or more embodiments, as mentioned, the generative extractive summary system uses the feedback set to train the LLM in one or more training operations. For example, the generative extractive summary system uses the feedback set to adjust parameters of the LLM to reduce differences between the initial extractive summary and the one or more coherent summaries based on the feedback set. In additional examples, the generative extractive summary system adjusts parameters of the LLM in a pre-finetuning step to reduce differences between the feedback set and a predicted feedback set generated by the LLM. Thus, in one or more embodiments, the generative extractive summary trains the LLM to generate coherent extractive summaries by learning to provide its own feedback internally according to the feedback set.

As mentioned, existing systems suffer from a number of drawbacks in relation to using machine-learning to generate extractive summaries of content. For example, although many conventional systems generate extractive summaries utilizing LLMs, such systems have a number of problems in relation to accuracy and flexibility. For instance, some conventional systems generate inaccurate extractive summaries by generating summary content that potentially contains factually accurate information to the digital document that is incoherently assembled (e.g., poorly organized or otherwise having low readability). To illustrate, some conventional systems generate inaccurate extractive summaries by selecting text or other content that removes or misconstrues important context in digital documents, such as excluding important details from an original text. Further, some conventional systems utilize other methods besides extractive summarization (e.g., abstractive summarization) to generate digital document summaries that are prone to introducing nonfactual content into the summary (e.g., due to incorrectly paraphrasing the content, and also due to the parametric hallucinations from the LLM used in the system).

Additionally, conventional systems are inflexible. For instance, certain conventional systems are limited to generating summaries that do not flexibly adapt to a variety of different digital documents. For example, certain conventional systems are limited to generating summaries for document types corresponding to certain document types or data types included in the training data. Additionally, some conventional systems are inflexible because they train on data in a specific domain to generate coherent extractive summaries for that domain. Thus, these conventional systems typically generate summaries that lack coherence unless generating extractive summaries in the specific domains for which the conventional systems have been trained, limiting their applicability outside the respective domains. Further, some conventional systems lack the ability to predict user-specific intent, limiting their flexibility in responding to user queries, and generate more user-readable content in extractive summaries.

As suggested, embodiments of the generative extractive summary system provide several improvements over conventional systems in relation to generating extractive summaries using machine-learning techniques. In contrast to conventional systems that lack accuracy due to poor selection and organization of extracted content, the generative extractive summary system provides improved accuracy by leveraging natural language annotations to train a LLM to generate coherent extractive summaries. For example, by conditioning an LLM on a feedback set including natural language annotations, the generative extractive summary system trains the LLM to generate extractive summaries having improved readability and structure relative to conventional systems. Specifically, by generating a feedback set including one or more coherent summaries, annotations that indicate how to improve an initial extractive summary to match the one or more coherent summaries, and quality scores, the generative extractive summary system trains the LLM to generate extractive summaries that are coherent, improving their accuracy. Further, by conditioning the LLM on the feedback set, the generative extractive summary system generates extractive summaries that are faithful to the original text in a digital document while being coherently organized for human readability.

The generative extractive summary system also improves flexibility relative to conventional systems. In contrast to conventional systems that are limited to generating summaries for a specific domain type, the generative extractive summary system provides extractive summarization across many different domains. For example, by conditioning an LLM on one or more text corpus domains (e.g., a plurality of different categories of content across various data domains), the generative extractive summary system generates coherent extractive summaries for different domains, including previously unseen domains. Further, by training the LLM based on feedback sets mimicking user feedback (e.g., via natural language annotations), the generative extractive summary system generates coherent extractive summaries that predict user-specific intent.

Additionally, the generative extractive summary system improves flexibility by providing a plurality of different training methods utilizing a feedback set for different types of machine-learning models. In particular, by providing a first training method that involves using the feedback set to finetune an LLM to align extractive summaries with a gold standard coherent summary (or ground-truth coherent summary), the generative extractive summary system provides improved accuracy in decoder-only LLMs. Furthermore, by providing a second training method that involves using the feedback set to train an LLM to provide accurate feedback internally while generating extractive summaries (e.g., in a supervised learning model) in pre-finetuning operations, the generative extractive summary system provides improved accuracy in encoder-decoder LLMs. Accordingly, the generative extractive summary system adapts the training method to the specific model type, as best serves a given implementation.

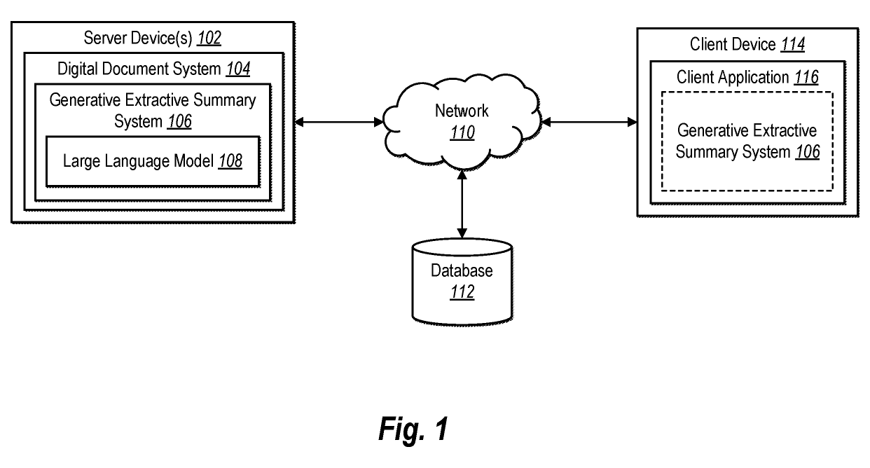

Additional detail regarding the generative extractive summary system will now be provided with reference to the figures. For example, FIG. 1 illustrates a schematic diagram of an example system environment for implementing a generative extractive summary system 106 in accordance with one or more embodiments. An overview of the generative extractive summary system 106 is described in relation to FIG. 1. Thereafter, a more detailed description of the components and processes of the generative extractive summary system 106 is provided in relation to the subsequent figures.

As shown, the environment includes server device(s) 102, a database 112, a network 110, and a client device 114. Each of the components of the environment communicate via the network 110, and the network 110 is any suitable network over which computing devices communicate.

As mentioned, the environment includes a client device 114. The client device 114 is one of a variety of computing devices, including a smartphone, a tablet, a smart television, a desktop computer, a laptop computer, a virtual reality device, an augmented reality device, or another computing device. The client device 114 communicates with the server device(s) 102 via the network 110. For example, the client device 114 provides information to server device(s) 102 indicating client device interactions (e.g., selecting a digital document or providing an annotation set) and receives information from the server device(s) 102 such as digital documents. Thus, in some cases, the generative extractive summary system 106 on the server device(s) 102 provides and receives information based on client device interaction via the client device 114.

As illustrated in FIG. 1, the environment includes the server device(s) 102. The server device(s) 102 generates, tracks, stores, processes, receives, and transmits electronic data, such as digital documents, initial extractive summaries, sets of annotations, coherent summaries, quality scores, and generative prompts. The server device(s) 102, for example, receives data from the client device 114 in the form of an indication of a client device interaction (e.g., a digital document or an annotation set) to train the LLM to reduce differences between the initial extractive summaries and the one or more coherent summaries. In response, the server device(s) 102 transmits data to the client device 114 to display or present a training dataset based on the client device interaction.

In some embodiments, the server device(s) 102 communicates with the client device 114 to transmit and/or receive data via the network 110, including client device interactions, digital documents, and/or other data. In some embodiments, the server device(s) 102 comprises a distributed server where the server device(s) 102 includes a number of server devices distributed across the network 110 and located in different physical locations. The server device(s) 102 comprise a content server, an application server, a communication server, a content editing server, a web-hosting server, a multidimensional server, and/or a machine learning server. The server device(s) 102 further access and utilize the database 112 to store and retrieve information such as digital documents, feedback sets, all or part of the large language model 108, and/or other data.

In one or more embodiments, a large language model refers to a neural network architecture trained to perform computer tasks to generate or identify computing code and/or data in response to prompts. In particular, a large language model includes a neural network (e.g., a deep neural network) with many (e.g., billions of) parameters pre-trained on large quantities of data (e.g., unlabeled text) using a particular learning technique (e.g., next-token prediction learning). For example, a large language model includes parameters trained to understand and generate text analogous to human text, such as synthetic prompts, synthetic responses, satisfaction labels, information data objects, and/or conversational goals. In one or more embodiments, LLMs use large datasets to analyze and predict language patterns to perform tasks like translation, summarization, and conversation. Further, in some embodiments, LLMs are built in a deep learning framework with many parameters to allow them to infer meaning, enabling sophisticated interactions across various domains.

Relatedly, in some embodiments, a neural network includes or refers to a machine learning model trained and/or tuned based on inputs to determine classifications, scores, or approximate unknown functions. For example, a neural network includes a model of interconnected artificial neurons (e.g., organized in layers) that communicate and learn to approximate complex functions and generate outputs (e.g., synthetic prompts, synthetic responses, satisfaction labels, information data objects, and/or conversational goals) based on a plurality of inputs provided to the neural network. In some cases, a neural network refers to an algorithm (or a set of algorithms) that implements deep learning techniques to model high-level abstractions in data. In one or more embodiments, a neural network includes various layers such as an input layer, one or more hidden layers, and an output layer that each perform tasks for processing data. For example, a neural network includes a deep neural network a convolutional neural network, a recurrent neural network (e.g., an LSTM), a graph neural network, or a large language model.

As further shown in FIG. 1, the server device(s) 102 also includes the generative extractive summary system 106 as part of a digital document system 104. For example, in one or more implementations, the digital document system 104 is able to store, generate, modify, edit, enhance, provide, distribute, and/or share digital documents. For example, the digital document system 104 provides tools for the client device 114, via the client application 116, to generate extractive summaries of digital documents, generate feedback sets, and/or adjust parameters of an LLM (e.g., the large language model 108). Accordingly, the digital document system 104 utilizes and/or trains the generative extractive summary system 106 to generate extractive summaries of digital documents via the tools provided to the client device 114 and/or to additional client devices or systems.

In one or more embodiments, the server device(s) 102 includes all, or a portion of, the generative extractive summary system 106. For example, the generative extractive summary system 106 operates on the server device(s) 102 to adjust parameters of an LLM (e.g., the large language model 108) for generating extractive summaries. In some cases, the generative extractive summary system 106 utilizes training data (e.g., feedback sets) locally on the server device(s) 102 or from another network location (e.g., the database 112) to adjust parameters of an LLM (e.g., the large language model 108) for generating extractive summaries.

In certain cases, the client device 114 includes all or part of the generative extractive summary system 106. For example, the client device 114 generates, obtains (e.g., downloads), or utilizes one or more aspects of the generative extractive summary system 106 from the server device(s) 102. Indeed, in some implementations, as illustrated in FIG. 1, the generative extractive summary system 106 is located in whole or in part on the client device 114. For example, the generative extractive summary system 106 includes a web hosting application that allows the client device 114 to interact with the server device(s) 102. To illustrate, in one or more implementations, the client device 114 accesses a web page supported and/or hosted by the server device(s) 102.

In one or more embodiments, the client device 114 and the server device(s) 102 work together to implement the generative extractive summary system 106. For example, in some embodiments, the server device(s) 102 train one or more LLMs (e.g., the large language model 108) discussed herein and provide the one or more LLMs to the client device 114 for implementation. In some embodiments, the server device(s) 102 trains an LLM (e.g., the large language model 108), and the client device 114 accesses the trained LLM at the server device(s) 102 to analyze a digital document. Furthermore, in some implementations, the client device 114 assists in training the LLM and/or executing the LLM (e.g., an instance of the LLM on the client device 114).

Although FIG. 1 illustrates a particular arrangement of the environment, in some embodiments, the environment has a different arrangement of components and/or may have a different number or set of components altogether. For instance, as mentioned, the generative extractive summary system 106 is implemented (e.g., located entirely or in part on) the client device 114. In addition, in one or more embodiments, the client device 114 communicates directly with the generative extractive summary system 106, bypassing the network 110. Further, in some embodiments, the large language model 108 includes one or more components stored in the database 112, maintained by the server device(s) 102, the client device 114, or a third-party device.

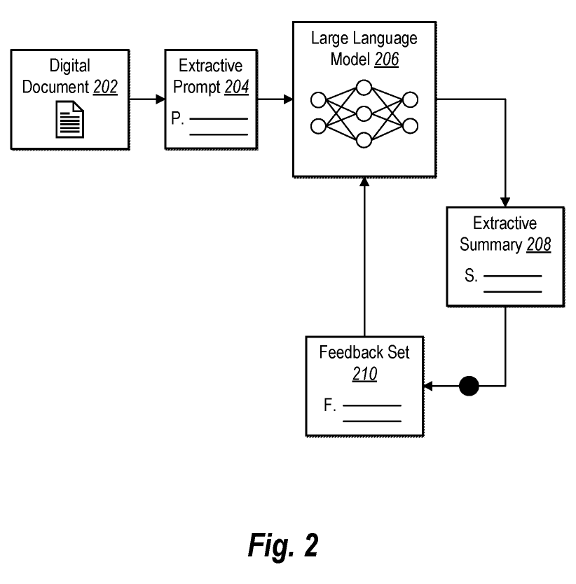

As mentioned, in one or more embodiments, the generative extractive summary system 106 trains an LLM using a feedback set corresponding to an initial extractive summary. FIG. 2 illustrates an overview of training an LLM by generating an extractive summary and an associated feedback set in accordance with one or more embodiments. Additional detail regarding the various acts and processes mentioned with respect to FIG. 2 is provided thereafter with respect to subsequent figures.

As illustrated in FIG. 2, the generative extractive summary system 106 receives a digital document 202 comprising text. In one or more embodiments, the generative extractive summary system 106 receives the digital document 202 from a client device (i.e., the client device 114). In one or more embodiments, the digital document 202 originates from one or more sources of digital text corpuses for training on natural language samples. For example, the digital text corpuses include text content related to various domains of data (e.g., news articles, policy/legal documents, TV show scripts, meeting transcripts, and/or labeled dialogue). In some embodiments, training a LLM on a number of different categories of data results in a more generalizable summary extraction process.

As further illustrated in FIG. 2, the generative extractive summary system 106 utilizes the digital document 202 to generate an extractive prompt 204. In one or more embodiments, the generative extractive summary system 106 generates the extractive prompt 204 to prompt an LLM (e.g., the large language model 206) to generate an extractive summary of the digital document 202. In one or more embodiments, the generative extractive summary system 106 generates the extractive prompt 204 to prompt an LLM to extract a set of one or more sentences from the digital document 202 forming a summary of the digital document 202.

In some cases, an extractive prompt refers to a prompt requesting an LLM (e.g., the large language model 206) to generate an extractive summary of a digital document (e.g., the digital document 202). In one or more embodiments, the generative extractive summary system 106 generates the extractive prompt. In one or more embodiments, a client device (e.g., the client device 114) provides the extractive prompt to the LLM. In one or more embodiments, the extractive prompt includes the digital document 202 (or text content of the digital document 202) and a request to generate an extractive summary including a set of sentences from the digital document 202 that summarize the contents of the digital document 202.

As further illustrated in FIG. 2, the generative extractive summary system 106 utilizes a large language model 206 to generate an extractive summary from the extractive prompt 204. In one or more embodiments, the generative extractive summary system 106 feeds the extractive prompt 204 into the large language model 206 to prompt the large language model 206 to generate an extractive summary (e.g., the extractive summary 208). More specifically, the generative extractive summary system 106 utilizes the large language model 206 to process the digital document 202 by extracting summary content according to the extractive prompt 204.

As further illustrated in FIG. 2, the generative extractive summary system 106 generates an extractive summary 208. In one or more embodiments, the generative extractive summary system 106 generates the extractive summary 208 to summarize the digital document 202. In one or more embodiments, the generative extractive summary system 106 generates the extractive summary 208 by extracting a series of sentences from the digital document 202. In one or more embodiments, the generative extractive summary system 106 generates the extractive summary 208 by extracting portions of several sentences from the digital document 202.

In some cases, an extractive summary refers to a summary generated by extracting one or more sentences from a digital document (e.g., the digital document 202). In one or more embodiments, the extractive summary includes whole sentences extracted from the digital document and reassembled into a summary. In one or more embodiments, the extractive summary includes portions of sentences extracted from the digital document assembled as a summary. Additionally, in some embodiments, the generative extractive summary system 106 generates an extractive summary by completing partial sentences or phrases with non-substantive modifications (e.g., by adding punctuation and articles or making grammatical changes such as verb tenses). In some embodiments, an extractive summary includes content that describes diverse content in a digital document while also concisely describing the diverse content.

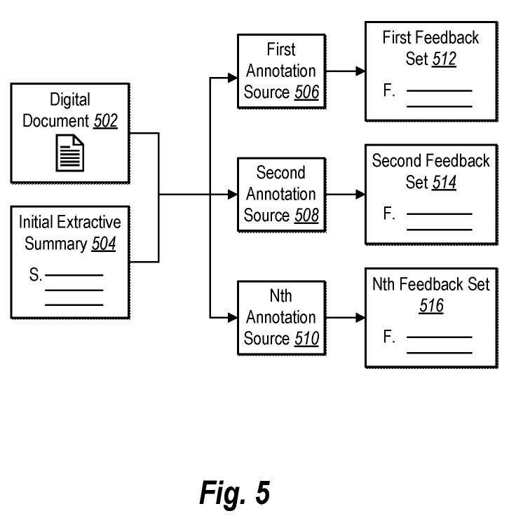

As further illustrated in FIG. 2, the generative extractive summary system 106 generates a feedback set 210. In one or more embodiments, the generative extractive summary system 106 generates the feedback set 210 including an evaluation of a coherence of the extractive summary 208 in relation to the digital document 202. In one or more embodiments, the generative extractive summary system 106 generates the feedback set 210 to include a set of annotations indicating corrections to the extractive summary 208. In additional embodiments, the generative extractive summary system 106 generates the feedback set 210 to include one or more coherent summaries that summarize the digital document 202 in a coherent manner and/or one or more quality scores evaluating the extractive summary 208. More information on generating the feedback set is given in relation to FIGS. 5-8.

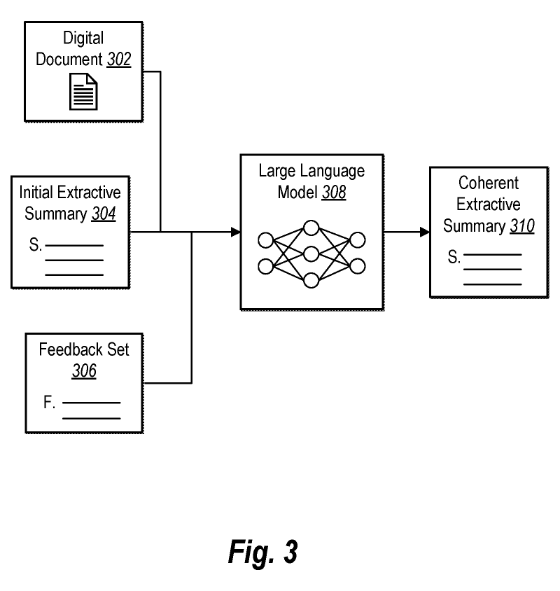

As mentioned, in one or more embodiments, the generative extractive summary system 106 trains an LLM by using a feedback set in accordance with one or more embodiments. FIG. 3 illustrates an overview of training an LLM utilizing feedback for an initial extractive summary generated by the LLM. Additional detail regarding the various acts and processes mentioned with respect to FIG. 3 is provided thereafter with respect to subsequent figures.

As illustrated in FIG. 3, the generative extractive summary system 106 receives a digital document 302 to summarize. In one or more embodiments, the generative extractive summary system 106 receives the digital document 302 as part of a request to analyze and/or summarize the digital document 302. For example, the generative extractive summary system 106 receives the digital document 302 from a database of digital documents (e.g., the database 112) in connection with processing one or more documents from the database. In one or more additional embodiments, the generative extractive summary system 106 receives the digital document 302 from a client device (e.g., the client device 114) as part of a request to analyze the digital document individually or as part of a group of digital documents.

As further illustrated in FIG. 3, the generative extractive summary system 106 generates an initial extractive summary 304. In one or more embodiments, the generative extractive summary system 106 generates the initial extractive summary 304 by dividing a digital document (e.g., the digital document 302) at the sentence level and creating a set of sentences (e.g., by parsing the digital document 302 into a set of all sentences). To illustrate, the generative extractive summary system 106 uses natural language processor to separate the digital document 302 into numbered sentences (or separate phrases). In one or more embodiments, the generative extractive summary system 106 prompts an LLM (e.g., the large language model 308) to produce a coherent summary of the digital document by selecting sentences from the set of sentences. For instance, the generative extractive summary system 106 includes the extracted set of sentences in a prompt to the LLM with a request to generate an extractive summary from the set of sentences.

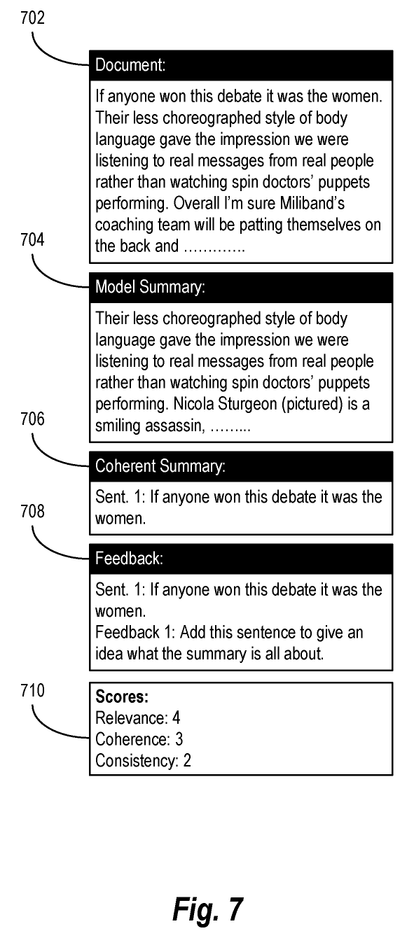

As further illustrated in FIG. 3, the generative extractive summary system 106 generates a feedback set 306. In one or more embodiments, the generative extractive summary system 106 generates the feedback set 306 to include a set of annotations explaining how to convert an initial extractive summary (e.g., the initial extractive summary 304) into a coherent extractive summary. For example, the feedback set 306 includes natural language annotations indicating changes to the initial extractive summary 304 to result in a coherent extractive summary. In additional embodiments, the feedback set 306 includes additional data, such as one or more scores indicating a quality of the initial extractive summary 304 and/or one or more coherent extractive summaries (e.g., a ground truth summary or a human generated summary of the digital document 302). More information on generating the set of annotations is provided in FIG. 7.

As further illustrated in FIG. 3, the generative extractive summary system 106 utilizes a large language model 308 to process one or more of the digital document 302, the initial extractive summary 304, and the feedback set 306 to generate the coherent extractive summary 310. In one or more embodiments, the generative extractive summary system 106 prompts the large language model 308 to process the digital document 302, the initial extractive summary 304, and the feedback set 306 as inputs. Accordingly, the generative extractive summary system 106 generates the coherent extractive summary 310 from the digital document 302 based on the initial extractive summary 304 and annotations correcting the initial extractive summary 304 in the feedback set 306 (e.g., relative to a gold standard coherent summary).

In one or more embodiments, the generative extractive summary system 106 trains the large language model 308 to reduce differences between an initial extractive summary 304 and the coherent extractive summary 310 by modifying parameters of the large language model 308. For example, the generative extractive summary system 106 uses the feedback set 306 to indicate to the large language model 308 how to improve the initial extractive summary 304 relative to the gold standard coherent summary based on the feedback set 306. As further illustrated in FIG. 3, the generative extractive summary system 106 utilizes the large language model 308 to generate a coherent extractive summary 310. In one or more embodiments, the generative extractive summary system 106 generates the coherent extractive summary 310 to improve the initial extractive summary 304 as modified by the feedback set 306. Thus, the generative extractive summary system 106 uses the feedback set 306 to train the large language model 308 to improve accuracy over the initial extractive summary 304 according to the annotations in the feedback set 306. In one or more additional embodiments, the generative extractive summary system 106 utilizes the coherent extractive summary 310 to further train the large language model 308 by calculating a loss between the initial extractive summary 304 and the coherent extractive summary 310 and adjusting parameters of the large language model 308 to reduce the loss (e.g., in an iterative process).

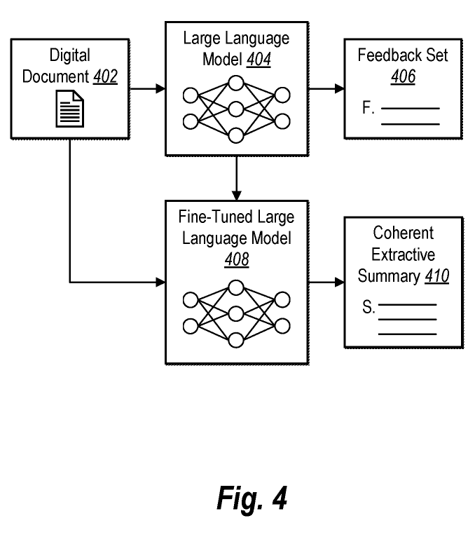

As mentioned, in one or more embodiments, the generative extractive summary system 106 trains an LLM in a pre-finetuning process according to a feedback set in accordance with one or more embodiments. FIG. 4 illustrates an overview of training an LLM according to a pre-finetuning embodiment. Additional detail regarding the various acts and processes mentioned with respect to FIG. 4 is provided thereafter with respect to subsequent figures.

As illustrated in FIG. 4, the generative extractive summary system 106 receives a digital document 402 to summarize. In one or more embodiments, the generative extractive summary system 106 accesses the digital document 402 from a database of text corpuses (e.g., the database 112 of FIG. 1) extracted from one or more of transcripts, videos, TV shows, or meetings. In one or more embodiments, the generative extractive summary system 106 receives the digital document 402 as an input from a client device (e.g., the client device 114 of FIG. 1). To illustrate, the generative extractive summary system 106 extracts the digital document 402 including a transcript from one or more of a video or TV show episode uploaded as an input from a client device with a request to summarize the transcript.

As further illustrated in FIG. 4, the generative extractive summary system 106 utilizes a large language model 404 to process the digital document 402 in an initial training step. Specifically, in one or more embodiments, the generative extractive summary system 106 feeds the digital document 402 into the large language model 404 along with a prompt to generate an annotated feedback set (e.g., the feedback set 406). In one or more embodiments, the generative extractive summary system 106 trains the large language model 404 in an additional training step to finetune the large language model 404, resulting in a fine-tuned large language model (e.g., the fine-tuned large language model 408) that is capable of reasoning how to create an extractive summary (e.g., by selecting an appropriate set of sentences from the digital document 402).

As mentioned, the generative extractive summary system 106 utilizes the large language model 404 to generate a feedback set 406 in an initial training step. In one or more embodiments, the feedback set 406 includes a predicted feedback set generated by the large language model 404 includes internal reasoning of how to select a set of sentences to generate an extractive summary of the digital document 402. To illustrate, the generative extractive summary system 106 generates a prompt including a request to the large language model 404 to cause the large language model 404 to generate a set of instructions for selecting sentences (e.g., annotations similar to the feedback set 306 of FIG. 3).

In one or more embodiments, the generative extractive summary system 106 utilizes the feedback set 406 to finetune the large language model 404. In some embodiments, the generative extractive summary system 106 utilizes a ground truth feedback set (e.g., a feedback set generated by an annotation source such as a user or a machine-learning model) to train the large language model 404. In particular, the generative extractive summary system 106 determines differences (e.g., via a loss function) between the ground truth feedback set and the feedback set 406 generated by the large language model 404. Additionally, the generative extractive summary system 106 utilizes the loss to train the large language model 404 to reduce the differences between the predicted set of annotations included in the feedback set 406 and the ground truth feedback set. Accordingly, the generative extractive summary system 106 trains the large language model 404 to generate accurate reasoning for selecting a set of sentences when generating an extractive summary relative to the ground truth feedback set. More information on generating the set of annotations is provided in relation to FIG. 7.

As further illustrated in FIG. 4, the generative extractive summary system 106 utilizes the fine-tuned large language model 408 to generate extractive summaries. For example, the generative extractive summary system 106 provides the digital document 402 to the fine-tuned large language model 408 to generate a coherent extractive summary 410 for the digital document 402. To illustrate, the fine-tuned large language model 408 utilizes the parameters pre-finetuned based on the differences between the feedback set 406 and the ground truth feedback set to select a set of sentences from the digital document 402 to include in the coherent extractive summary 410.

In one or more additional embodiments, the generative extractive summary system 106 further trains the fine-tuned large language model 408 to generate coherent extractive summaries. Specifically, the generative extractive summary system 106 further trains the fine-tuned large language model 408 by utilizing a training process similar to the process described in FIG. 3. To illustrate, the generative extractive summary system 106 utilizes the fine-tuned large language model 408 to generate the coherent extractive summary 410 from the digital document 402, generating an additional feedback set (e.g., based on annotations from an annotation source), and further modifying the fine-tuned large language model 408 based on the additional feedback set. Thus, in some embodiments, the generative extractive summary system 106 utilizes a combination of separate training types to train an LLM to generate coherent extractive summaries.

As mentioned, in one or more embodiments, the generative extractive summary system 106 generates one or more sets of feedback for an initial extractive summary generated by an LLM. FIG. 5 illustrates an overview of generating one or more feedback sets for an initial extractive summary via a plurality of different annotation sources. For instance, as described in more detail below, annotation sources for generating feedback sets include human annotators, machine-learning models, or a combination of human annotators and machine-learning models.

As illustrated in FIG. 5, the generative extractive summary system 106 determines a digital document 502 and an initial extractive summary 504 generated for the digital document 502 by an LLM. In particular, as previously described, the generative extractive summary system 106 generates the initial extractive summary 504 by prompting an LLM to extract a set of sentences from the digital document 502 and select one or more sentences from the set of sentences to summarize the digital document 502. In one or more embodiments, the generative extractive summary system 106 provides the digital document 502 and the initial extractive summary 504 to a plurality of annotation sources to generate feedback (e.g., annotations) for improving the initial extractive summary 504.

For example, as further illustrated in FIG. 5, the generative extractive summary system 106 utilizes a first annotation source 506 to generate a first feedback set 512 from the digital document 502 and the initial extractive summary 504. For example, the first annotation source 506 includes a machine-learning model (e.g., an LLM) or a human annotator. In one or more embodiments in which the first annotation source 506 includes an LLM, the generative extractive summary system 106 prompts the first annotation source 506 to compare the digital document 502 and the initial extractive summary 504 to and generate instructions for improving the initial extractive summary 504. For example, the generative extractive summary system 106 instructs the first annotation source 506 to generate annotations (e.g., natural language instructions) for modifying a set of sentences in the initial extractive summary 504 to obtain a gold standard extractive summary (e.g., a ground truth extractive summary). Accordingly, the annotations include instructions indicating that the set of sentences in the initial extractive summary 504 is missing one or more sentences from the digital document 502 or that the set of sentences should not have one or more sentences.

As further illustrated in FIG. 5, the generative extractive summary system 106 utilizes a second annotation source 508 to generate a second feedback set 514 from the digital document 502 and the initial extractive summary 504. As noted previously, the second annotation source 508 includes a machine-learning model or a human annotator. In one or more embodiments in which the second annotation source 508 includes a human annotator, the generative extractive summary system 106 provides the digital document 502 and the initial extractive summary 504 to a client device of the human annotator. The client device detects inputs to generate annotations (e.g., natural language instructions) indicating how to modify the initial extractive summary 504 to result in a gold standard extractive summary. In one or more embodiments, the gold standard extractive summary includes a ground truth summary generated by the human annotator or provided to the client device of the human annotator by the generative extractive summary system 106.

As further illustrated in FIG. 5, the generative extractive summary system 106 utilizes any number of annotation sources (e.g., an nth annotation source 510) to generate feedback sets (e.g., an nth feedback set 516) from the digital document 502 and the initial extractive summary 504. Accordingly, the generative extractive summary system 106 utilizes any combination of sources (e.g., human annotators and/or machine-learning models). In one or more embodiments, the generative extractive summary system 106 utilizes only human annotators to generate feedback sets. Alternatively, the generative extractive summary system 106 utilizes machine-learning models trained on training datasets including human-generated feedback sets for improved efficiency of computing systems implementing the generative extractive summary system 106. Thus, in one or more embodiments, the generative extractive summary system 106 utilizes a combination of human annotators and machine-learning models to ensure that the LLM learns to generate extractive summaries for human readability while also improving the efficiency of generating training datasets via machine-learning models.

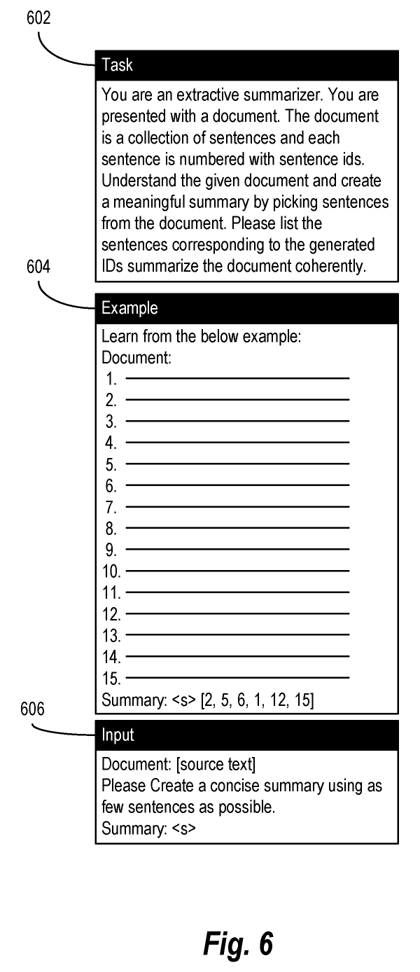

As mentioned, in one or more embodiments, the generative extractive summary system 106 prompts an LLM to generate a coherent summary. FIG. 6 illustrates an example of a prompt that the generative extractive summary system 106 generates for providing to an LLM to generate a coherent summary from a digital document in accordance with one or more embodiments.

As illustrated in FIG. 6, the generative extractive summary system 106 generates a prompt for an LLM. In one or more embodiments, the generative extractive summary system 106 generates the prompt including a task 602 to define the goal for the LLM (e.g., summarizing the document) as well as how to accomplish the goals (e.g., by picking sentences from the document). For example, in one or more embodiments, the generative extractive summary system 106 generates the task 602 to instruct the LLM to assume the role of an extractive summarizer, pick sentences to form a meaningful summary, and list the IDs attached to each sentence selected (e.g., based on the provided sentence IDs).

As further illustrated in FIG. 6, the generative extractive summary system 106 utilizes an example summary 604 to guide the extractive summarization prompted by the task 602. In one or more embodiments, the generative extractive summary system 106 generates the example summary 604 to explain which sentences to select from an example document to generate a coherent extractive summary. As illustrated, the example document includes a set of numbered sentences corresponding to an order of sentences extracted from a digital document. In one or more embodiments, the generative extractive summary system 106 provides the example summary 604 by including a prior coherent extractive summary of the same digital document (e.g., via a listing of sentence IDs corresponding to selected sentences from the example document).

As further illustrated in FIG. 6, the generative extractive summary system 106 further provides an input 606 to the LLM. In one or more embodiments, the generative extractive summary system 106 attaches the input 606 with a digital document for the LLM to summarize. To illustrate, the generative extractive summary system 106 provides, for the digital document, a set of numbered sentences that the generative extractive summary system 106 extracts from the digital document. In one or more embodiments, the generative extractive summary system 106 attaches the input 606 with further instructions, such as instructing the LLM to summarize the document in as few sentences as possible or instructing the LLM to summarize the document with a particular user goal in mind and/or a format of a summary.

As mentioned, in one or more embodiments, the generative extractive summary system 106 generates feedback sets including annotations for correcting an initial extractive summary. FIG. 7 illustrates an example feedback set including annotations in accordance with one or more embodiments.

As illustrated in FIG. 7, the generative extractive summary system 106 generates the feedback set in reference to a document 702. In one or more embodiments, the generative extractive summary system 106 attaches the document 702 to the feedback set as a reference for an LLM. In one or more embodiments, the generative extractive summary system 106 replicates the text of the document 702 in the feedback set. In one or more embodiments, the generative extractive summary system 106 attaches the document 702 as a separate file accompanying the feedback set.

As further illustrated in FIG. 7, the generative extractive summary system 106 further includes a model summary 704 in the feedback set. In one or more embodiments, the generative extractive summary system 106 generates the model summary 704 by prompting an LLM to generate an extractive summary of the document 702. In one or more embodiments, the generative extractive summary system 106 generates the model summary 704 utilizing an untrained LLM. Accordingly, in one or more embodiments, the model summary 704 includes an initial extractive summary that the generative extractive summary system 106 generates utilizing the untrained LLM.

As further illustrated in FIG. 7, the generative extractive summary system 106 provides a coherent summary 706 of the document 702. In particular, the generative extractive summary system 106 generates the coherent summary 706 as a gold standard extractive summary of the document 702 (e.g., from one or more coherent summaries generated for the document 702). In one or more embodiments, the generative extractive summary system 106 generates the gold standard extractive summary to include a ground truth set of sentences that summarize the document 702.

For example, the generative extractive summary system 106 determines one or more ground truth set of sentences based on input from one or more client devices (e.g., based on input by human annotators). To illustrate, the generative extractive summary system 106 determines a ground truth set of sentences selected by an annotation source and corresponding to feedback generated by the annotation source. Alternatively, the generative extractive summary system 106 determines a single coherent summary for use across a plurality of annotation sources. Thus, the generative extractive summary system 106 utilizes one or more coherent summaries to generate a plurality of feedback instances based on a plurality of annotation sources.

As further illustrated in FIG. 7, the generative extractive summary system 106 provides feedback 708 in the form of annotations. In one or more embodiments, the generative extractive summary system 106 generates the feedback 708 to include sentences from the document 702 that appeared in the coherent summary 706 and not in the model summary 704. In one or more embodiments, the generative extractive summary system 106 generates the feedback 708 to include a natural language explanation of how adding the sentences from the document 702 included in the coherent summary 706 and not included in the model summary 704 would improve the coherence of the model summary 704. Additionally, in various embodiments, the generative extractive summary system 106 generates the feedback 708 to include indications of one or more sentences to exclude from the model summary 704 and an explanation of why the model summary 704 should not include the one or more sentences. In one or more embodiments, the generative extractive summary system 106 provides the feedback 708 as an attached document generated by one or more of a machine-learning model or a client device of a human annotator.

As further illustrated in FIG. 7, the generative extractive summary system 106 generates a set of quality scores 710 evaluating the suitability of the model summary 704. In one or more embodiments, the generative extractive summary system 106 generates the set of quality scores 710 to include one or more of a relevance score, a coherence score, and a consistency score. In one or more embodiments, the generative extractive summary system 106 generates the set of quality scores 710 on one or more value scales (e.g., 1-5, with 5 indicating a high degree of suitability and 1 indicating a low degree of suitability for the associated value).

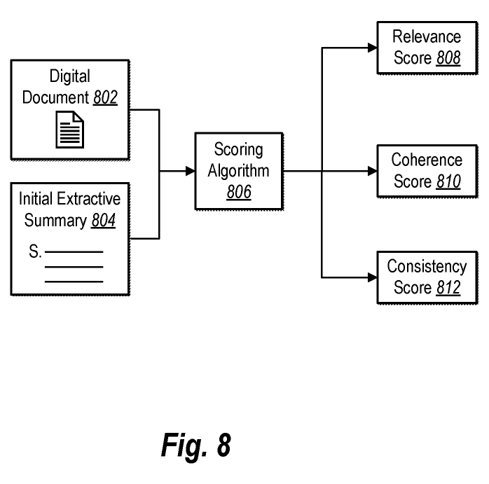

As mentioned, in one or more embodiments, the generative extractive summary system 106 generates one or more quality scores for an initial extractive summary. FIG. 8 illustrates a diagram of generating a set of one or more quality scores for an initial extractive summary utilizing a scoring algorithm in accordance with one or more embodiments.

As illustrated in FIG. 8, the generative extractive summary system 106 receives a digital document 802 and an initial extractive summary 804 generated for the digital document 802 by an LLM. As further illustrated in FIG. 8, the generative extractive summary system 106 generates quality scores for the initial extractive summary 804 relative to the digital document 802 according to a scoring algorithm 806. In one or more embodiments, the generative extractive summary system 106 determines the quality scores (e.g., utilizing a machine-learning model and/or based on inputs from one or more annotation sources) evaluating various attributes of the initial extractive summary 804 as a summary of the digital document 802. In one or more embodiments, the generative extractive summary system 106 determines quality scores that indicate one or more metrics (i.e., relevance, coherence, consistency) and uses the quality scores to evaluate a quality of the initial extractive summary 804 according to the defined metrics. In one or more embodiments, the generative extractive summary system 106 prompts a machine-learning model with a scoring algorithm 806 to cause the machine-learning model to generate the quality scores based on various metrics.

As further illustrated in FIG. 8, the generative extractive summary system 106 utilizes the scoring algorithm 806 to generate a relevance score 808. In one or more embodiments, the generative extractive summary system 106 generates the relevance score 808 to evaluate whether the initial extractive summary 804 selected key points from the digital document 802 to include within its summarization. In one or more embodiments, the generative extractive summary system 106 generates the relevance score 808 to indicate whether the initial extractive summary 804 only included important information from the digital document 802 and excluded less important information. In one or more embodiments, the generative extractive summary system 106 generates the relevance score 808 according to a particular scoring scale (e.g., from 1-5, with a score of 5 indicating a highly relevant extractive summary and a score of 1 indicating an extractive summary with low relevance).

As further illustrated in FIG. 8, the generative extractive summary system 106 utilizes the scoring algorithm 806 to generate a coherence score 810. In one or more embodiments, the generative extractive summary system 106 generates the coherence score 810 to evaluate whether the initial extractive summary 804 is well-structured and well-organized to a reader. In one or more embodiments, the generative extractive summary system 106 generates the coherence score 810 to indicate the collective quality of the sentences selected from the digital document 802 for the initial extractive summary 804. In one or more embodiments, the generative extractive summary system 106 generates the coherence score 810 according to a particular scale (e.g., from 1-5, with a score of 5 indicating a high degree of coherence and a score of 1 indicating a lack of coherence).

As further illustrated in FIG. 8, the generative extractive summary system 106 utilizes the scoring algorithm 806 to generate a consistency score 812. In one or more embodiments, the generative extractive summary system 106 generates the consistency score 812 to evaluate whether the initial extractive summary 804 only includes statements included within the digital document 802. In one or more embodiments, the generative extractive summary system 106 generates the consistency score 812 to evaluate the factual consistency of the initial extractive summary 804 as compared to the digital document 802. In one or more embodiments, the generative extractive summary system 106 generates the consistency score 812 according to a particular scale (e.g., from 1-5, with a score of 5 indicating a high degree of consistency and a score of 1 indicating a lack of consistency).

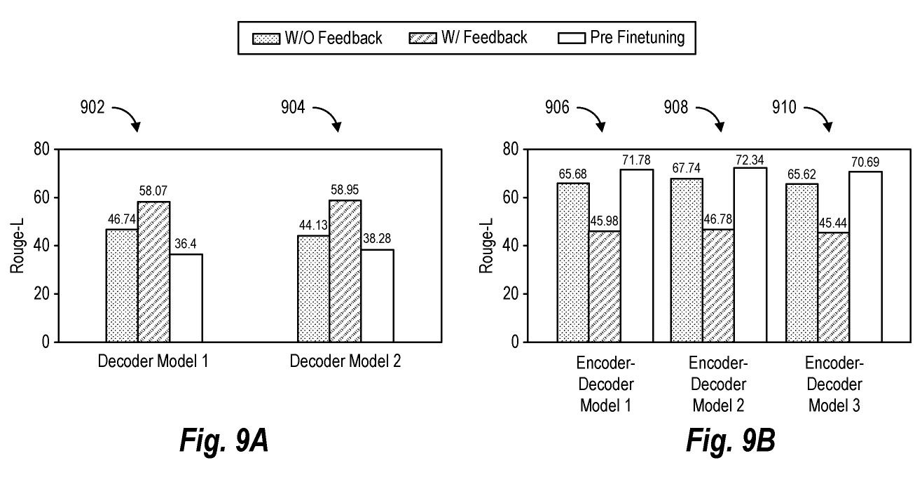

As mentioned, in one or more embodiments, the generative extractive summary system 106 presents several advantages in training extractive summarization systems over existing systems. Indeed, experimenters have demonstrated performance of the generative extractive summary system 106. FIGS. 9A-9B illustrate graphical representations of experimental performance metrics of the generative extractive summary system 106 in accordance with one or more embodiments. FIG. 9A illustrates a graphical representation of experimental performance metrics when utilized on decoder-only models. FIG. 9B illustrates a graphical representation of experimental performance metrics when utilized on encoder-decoder models.

As illustrated in FIG. 9A, in one or more embodiments, the graph 902 depicts the results of utilizing three methods to train a first decoder-only model. In some embodiments, the graph 902 depicts the results of utilizing an untrained first decoder-only model (e.g., “w/o Feedback”), utilizing a first decoder-only model trained according to the feedback training method illustrated in FIG. 3 (e.g., “w/Feedback”), and utilizing a first decoder-only model trained according to the pre-finetuning training method illustrated in FIG. 4 (e.g., “Pre-Finetuning”). In one or more embodiments, the graph 902 depicts the three different trained versions of the first decoder-only model scored according to Rogue-L, a metric used to evaluate the quality of a generated text (i.e., an extractive summary) compared to a reference text (i.e., a digital document) by measuring sentence-level fluency and similarity. As illustrated, the graph 902 indicates that the first decoder-only model trained according to the feedback training method performed better than the untrained first decoder-only model while the pre-finetuned first decoder-only model performed worse than the untrained first decoder-only model.

In some cases, a decoder in the context of an LLM refers to a feature for generating text by predicting the next token (e.g., word, sentence, paragraph, etc.) in a sequence based on prior tokens. In some embodiments, a decoder utilizes self-attention mechanisms to understand relationships between the tokens in an input and generates a most likely sequence based on the probability distribution of the input. In some embodiments, a decoder generates the most likely sequence by incorporating positional encodings to preserve word order.

As further illustrated in FIG. 9A, the graph 904 demonstrates the results of utilizing three methods to train a second decoder-only model. As illustrated, the graph 904 indicates that the second decoder-only model trained according to the feedback training method performed better than the untrained second decoder-only model while the pre-finetuned second decoder-only model performed worse than the untrained second decoder-only model.

As illustrated in FIG. 9B, in one or more embodiments, the graph 906 depicts the results of using three methods to train a first encoder-decoder model. In some embodiments, the graph 906 depicts the results of utilizing an untrained first encoder-decoder model (e.g., “w/o Feedback”), utilizing a first encoder-decoder model trained according to the feedback training method illustrated in FIG. 3 (e.g., “w/Feedback”), and utilizing a first encoder-decoder model trained according to the pre-finetuning training method illustrated in FIG. 4 (e.g., “Pre-Finetuning”). In one or more embodiments, the graph 902 depicts the three different trained versions of the first encoder-decoder model scored according to Rogue-L, a metric used to evaluate the quality of a generated text (i.e., an extractive summary) compared to a reference text (i.e., a digital document) by measuring sentence-level fluency and similarity. As illustrated, the graph 906 indicates that the first encoder-decoder model trained according to the feedback training method performed worse than the untrained first encoder-decoder model while the first encoder-decoder model trained according to the pre-finetuned training method performed better than the untrained first encoder-decoder model.

In some cases, an encoder in the context of an LLM refers to a feature for processing input text to create contextualized representations of the text. In one or more embodiments, an encoder utilizes self-attention and feedforward layers to capture relationships between parts of the text. This enables the LLM to understand context within the input, encoding semantic and syntactic context for the LLM.

As further illustrated in FIG. 9B, the graph 908 demonstrates the results of utilizing three methods to train a second encoder-decoder model. As illustrated, the graph 908 indicates that the second encoder-decoder model trained according to the feedback training method performed worse than the untrained second encoder-decoder model while the pre-finetuned second encoder-decoder model performed better than the untrained second encoder-decoder model.

As further illustrated in FIG. 9B, the graph 910 demonstrates the results of utilizing three methods to train a third encoder-decoder model. As illustrated, the graph 910 indicates that the third encoder-decoder model trained according to the feedback training method performed worse than the untrained third encoder-decoder model while the pre-finetuned third encoder-decoder model performed better than the untrained third encoder-decoder model.

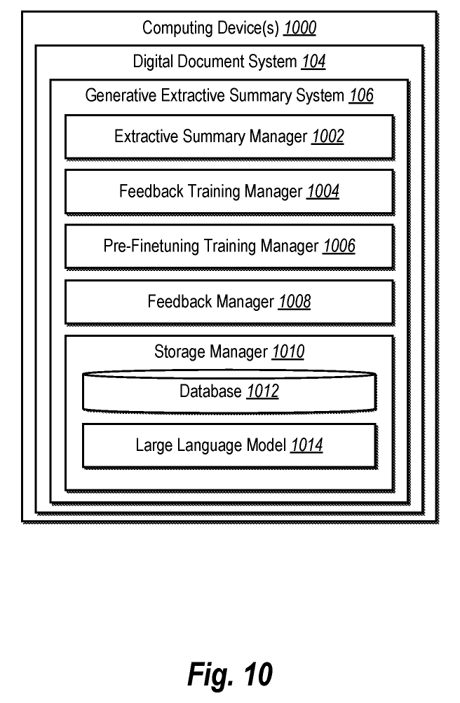

Referring now to FIG. 10, additional detail will be provided regarding components and capabilities of the generative extractive summary system 106. Specifically, FIG. 10 illustrates an example schematic diagram of the generative extractive summary system 106 on an example computing device(s) 1000 (e.g., one or more of the client device 114 and the server device(s) 102). As shown in FIG. 10, the generative extractive summary system 106 includes an extractive summary manager 1002, a feedback training manager 1004, a pre-finetuning training manager 1006, a feedback manager 1008, and a storage manager 1010.

As mentioned, the generative extractive summary system 106 includes an extractive summary manager 1002. In particular, the extractive summary manager 1002 generates, modifies, or alters an extractive summary (e.g., the initial extractive summary 304, the initial extractive summary 504, or the coherent extractive summary 410). For example, the extractive summary manager 1002 generates an initial extractive summary and one or more coherent summaries to use to train an LLM to generate coherent extractive summaries.

As mentioned, the generative extractive summary system 106 includes a feedback training manager 1004. In particular, the feedback training manager 1004 supervises, modifies, alters, or augments a feedback training method (e.g., the feedback training method illustrated in FIG. 3). For example, the feedback training manager 1004 trains an LLM by training the model with a digital document, an initial extractive summary, and a feedback set as input and a coherent extractive summary as output.

As mentioned, the generative extractive summary system 106 includes a pre-finetuning training manager 1006. In particular, the pre-finetuning training manager 1006 supervises, modifies, alters, or augments a pre-finetuning training method (e.g., the pre-finetuning training method illustrated in FIG. 4). For example, the pre-finetuning training manager 1006 trains an LLM by initially fine-tuning the model with a digital document as input and a feedback set as output, then further fine-tuning the model with the digital document as input and a coherent extractive summary as the output.

As mentioned, the generative extractive summary system 106 includes a feedback manager 1008. In particular, the feedback manager 1008 generates, modifies, or alters a feedback set evaluating the suitability of an initial extractive summary as compared to a coherent extractive summary. For example, the feedback manager 1008 generates a feedback set for an initial extractive summary including one or more of a set of annotations, one or more coherent summaries, and one or more quality scores.

The generative extractive summary system 106 further includes a storage manager 1010. The storage manager 1010 operates in conjunction with the other components of the generative extractive summary system 106 and includes one or more memory devices such as the database 1012 (e.g., the database 112) that stores various data such as digital documents, feedback sets, and other information. In some cases, the storage manager 1010 also manages or maintains a large language model 1014 for generating extractive summaries and feedback sets using one or more components of the generative extractive summary system 106 as described above.

In one or more embodiments, each of the components of the generative extractive summary system 106 are in communication with one another using any suitable communication technologies. Additionally, the components of the generative extractive summary system 106 are in communication with one or more devices including one or more client devices described above. It will be recognized that although the components of the generative extractive summary system 106 are shown to be separate in FIG. 10, any of the subcomponents may be combined into fewer components, such as into a single component, or divided into more components as may serve a particular implementation. Furthermore, although the components of FIG. 10 are described in connection with the generative extractive summary system 106, at least some of the components for performing operations in conjunction with the generative extractive summary system 106 described herein may be implemented on other devices within the environment.

The components of the generative extractive summary system 106 include software, hardware, or both. For example, the components of the generative extractive summary system 106 include one or more instructions stored on a computer-readable storage medium and executable by processors of one or more computing devices (e.g., the computing device(s) 1000). When executed by the one or more processors, the computer-executable instructions of the generative extractive summary system 106 cause the computing device(s) 1000 to perform the methods described herein. Alternatively, the components of the generative extractive summary system 106 comprise hardware, such as a special purpose processing device to perform a certain function or group of functions. Additionally, or alternatively, the components of the generative extractive summary system 106 include a combination of computer-executable instructions and hardware.

Furthermore, the components of the generative extractive summary system 106 performing the functions described herein may, for example, be implemented as part of a stand-alone application, as a module of an application, as a plug-in for applications including content management applications, as a library function or functions that may be called by other applications, and/or as a cloud-computing model. Thus, the components of the generative extractive summary system 106 may be implemented as part of a stand-alone application on a personal computing device or a mobile device. Alternatively, or additionally, the components of the generative extractive summary system 106 may be implemented in any application that allows creation and delivery of content to users, including, but not limited to, applications such as ADOBE® DOCUMENT CLOUD®, ADOBE® ACROBAT®, and ADOBE® PREMIERE®, which are either registered trademarks or trademarks of Adobe Inc. in the United States and/or other countries.

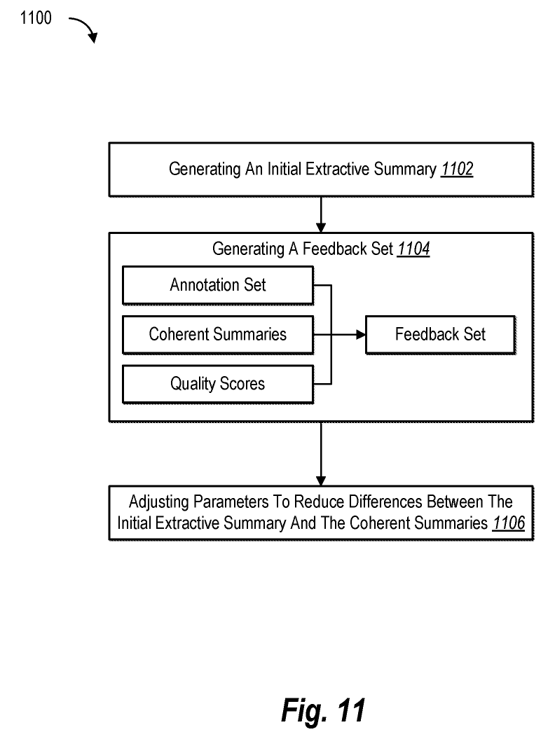

FIGS. 1-10, the corresponding text, and the examples provide a number of different systems, methods, and non-transitory computer readable media for adjusting parameters for a large language model from an initial extractive summary and a feedback set. In addition to the foregoing, embodiments are described in terms of flowcharts comprising acts for accomplishing a particular result. For example, FIG. 11 illustrates a flowchart of example sequences or series of acts in accordance with one or more embodiments.

While FIG. 11 illustrates acts according to particular embodiments, alternative embodiments may omit, add to, reorder, and/or modify any of the acts shown in FIG. 11. In one or more embodiments, the acts of FIG. 11 are performed as part of a method. Alternatively, a non-transitory computer readable medium comprises instructions, that when executed by one or more processors, cause a computing device to perform the acts of FIG. 11. In still further embodiments, a system performs the acts of FIG. 11. Additionally, the acts described herein may be repeated or performed in parallel with different instances of the same or other similar acts.

FIG. 11 illustrates an example series of acts 1100 for training an LLM to generate coherent extractive summaries. In particular, the series of acts 1100 includes an act 1102 of generating an initial extractive summary. For example, the act 1102 involves generating an initial extractive summary of a digital document by utilizing a large language model. Further, the series of acts 1100 includes an act 1104 of generating a feedback set. For example, the act 1104 involves generating a feedback set that includes a set of annotations indicating corrections to the initial extractive summary relative to one or more coherent summaries of the digital document and a set of quality scores for the initial extractive summary. Further, the series of acts 1100 includes an act 1106 of adjusting parameters to reduce differences between the initial extractive summary and the coherent summaries. For example, the act 1106 involves adjusting parameters of the large language model to reduce differences between the initial extractive summary and the one or more coherent summaries based on the feedback set.

In some embodiments, the series of acts 1100 includes extracting a set of sentences from the digital document by dividing the digital document at a sentence level; and prompting the large language model to generate the initial extractive summary by selecting a subset of sentences from the set of sentences.

In some embodiments, the series of acts 1100 includes generating one or more coherent summaries of the digital document based on inputs from one or more annotation sources; and generating the set of annotations comprising natural language explanations indicating how to modify the initial extractive summary to obtain the one or more coherent summaries.

In some embodiments, the series of acts 1100 includes utilizing an annotation source to select a set of sentences from the digital document indicating contextual and semantic summary content of the digital document; and determine a coherent summary including summarized content of the digital document based on the set of sentences.

In some embodiments, the series of acts 1100 includes generating a comparison of the initial extractive summary and the one or more coherent summaries; and generating a natural language explanation of converting the initial extractive summary to the one or more coherent summaries based on the comparison.

In some embodiments, the series of acts 1100 includes generating a first quality score indicating a relevance of content in initial extractive summary in relation to the digital document. The series of acts 1100 also includes generating a second quality score indicating a coherence of the initial extractive summary based on a structure and organization of content in the initial extractive summary; and generating a third quality score indicating a consistency of the initial extractive summary relative to a plurality of sentences in the digital document.

In some embodiments, the series of acts 1100 includes generating, utilizing the large language model with the adjusted parameters, an additional extractive summary for an additional digital document.

In some embodiments, the series of acts 1100 includes generating, utilizing a first machine-learning model, a first set of annotations indicating first corrections to the initial extractive summary relative to the one or more coherent summaries of the digital document; and generating, utilizing a second machine-learning model, a second set of annotations indicating second corrections to the initial extractive summary relative to the one or more coherent summaries of the digital document.

In some embodiments, the series of acts 1100 includes generating, utilizing a large language model, an initial extractive summary of a digital document; generating a feedback set comprising a set of annotations indicating corrections to the initial extractive summary relative to one or more coherent summaries of the digital document; generating, utilizing the large language model and from the digital document, a predicted feedback set comprising a set of predicted annotations for the digital document; and adjusting parameters of the large language model to reduce differences between the feedback set and the predicted feedback set.

In some embodiments, the series of acts 1100 includes generating the initial extractive summary of the digital document by prompting the large language model to select a set of sentences from the digital document and summarize the digital document based on the set of sentences.

In some embodiments, the series of acts 1100 includes generating the feedback set by: prompting a first machine-learning model to generate a first set of annotations indicating one or more differences between a set of sentences selected from the digital document by the large language model for generating the initial extractive summary and a first additional set of sentences used to generate the one or more coherent summaries; and prompting a second machine-learning model to generate a second set of annotations indicating one or more differences between the set of sentences selected from the digital document by the large language model for generating the initial extractive summary and a second additional set of sentences used to generate the one or more coherent summaries.

In some embodiments, the series of acts 1100 includes adjusting parameters of the large language model by: prompting the large language model with the digital document to generate the set of predicted annotations of the predicted feedback set; determining a loss indicating the differences between the set of annotations of the feedback set and the set of predicted annotations of the predicted feedback set; and adjusting the parameters of the large language model to reduce the differences based on the loss.

In some embodiments, the series of acts 1100 includes generating, utilizing the large language model with the adjusted parameters, an additional extractive summary of the digital document and generating the feedback set comprising a set of quality scores indicating one or more of a relevance, a coherence, or a consistency of the initial extractive summary.

In some embodiments, the series of acts 1100 includes generating the feedback set comprising a feedback instance including: the digital document; the initial extractive summary; a natural language explanation for modifying the initial extractive summary to create a coherent summary of the one or more coherent summaries; the coherent summary of the one or more coherent summaries; and a set of quality scores for the initial extractive summary

In some embodiments, the series of acts 1100 includes generating, utilizing a large language model, an initial extractive summary of a digital document utilizing a set of sentences extracted from the digital document to summarize the digital document; generating a feedback set comprising: a set of annotations indicating corrections to the initial extractive summary or the set of sentences extracted from the digital document; one or more coherent summaries of the digital document; and a set of quality scores indicating at least a coherence of the initial extractive summary; and adjusting parameters of the large language model to reduce differences between the initial extractive summary and the one or more coherent summaries of the digital document based on the feedback set.

In some embodiments, the series of acts 1100 includes dividing the digital document at a sentence level into a plurality of sentences; and prompting the large language model to generate the initial extractive summary by: selecting a subset of sentences from the plurality of sentences; and generating the initial extractive summary based on the subset of sentences.

In some embodiments, the series of acts 1100 includes determining the set of annotations comprising natural language explanations for modifying the initial extractive summary to obtain the one or more coherent summaries.

In some embodiments, the series of acts 1100 includes generating, utilizing one or more machine-learning models: the set of annotations indicating the corrections to the initial extractive summary or the set of sentences extracted from the digital document; the one or more coherent summaries of the digital document; and the set of quality scores indicating at least the coherence of the initial extractive summary.

In some embodiments, the series of acts 1100 includes determining a loss indicating the differences between the initial extractive summary and the one or more coherent summaries by providing the digital document, the initial extractive summary, and the feedback set to the large language model; and finetuning the parameters of the large language model to reduce the differences between the initial extractive summary and the one or more coherent summaries based on the loss.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media. Non-transitory computer-readable storage media (devices) includes optical and/or non-optical memory, disks, or caches that store computer data interpretable by one or more processors to execute particular functions as described herein. A “network” is defined as one or more data links that enable the transport of electronic data between computer systems and/or modules and/or other electronic devices. Information is transferred or provided over a network (either hardwired, wireless, or a combination of hardwired or wireless) to a computer to carry program code in the form of computer-executable instructions or data structures and which can be accessed by a general purpose or special purpose computer.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code.

Embodiments of the present disclosure can also be implemented in cloud computing environments. In this description, “cloud computing” is defined as a model for enabling on-demand network access to a shared pool of configurable computing resources. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth.

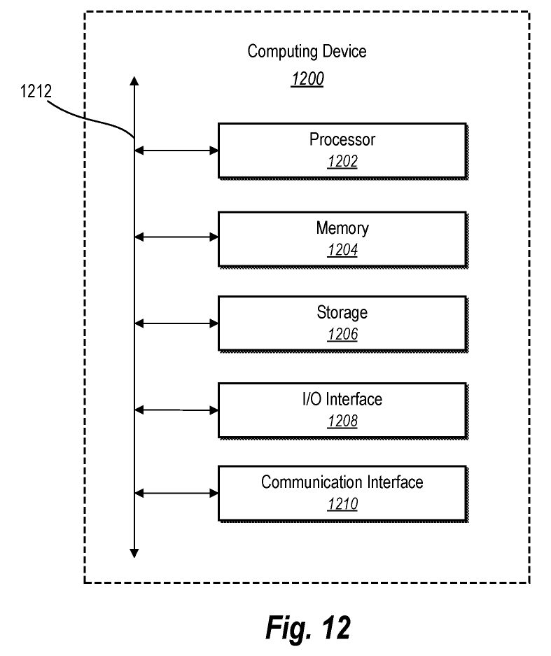

FIG. 12 illustrates, in block diagram form, an example computing device 1200 (e.g., the computing device(s) 800, the client device 114, and/or the server device(s) 102) that may be configured to perform one or more of the processes described above. As shown by FIG. 12, the computing device can comprise a processor(s) 1202, memory 1204, a storage device 1206, an I/O interface 1208, and a communication interface 1210.

In particular embodiments, processor(s) 1202 includes hardware for executing instructions, such as those making up a computer program. As an example, and not by way of limitation, to execute instructions, processor(s) 1202 may retrieve (or fetch) the instructions from an internal register, an internal cache, memory 1204, or a storage device 1206 and decode and execute them. The computing device 1200 includes memory 1204, which is coupled to the processor(s) 1202. The memory 1204 may be used for storing data, metadata, and programs for execution by the processor(s). The memory 1204 may include one or more of volatile and non-volatile memories. The memory 1204 may be internal or distributed memory. The computing device 1200 includes a storage device 1206 includes storage for storing data or instructions. As an example, and not by way of limitation, storage device 1206 can comprise a non-transitory storage medium described above. The computing device 1200 also includes one or more input or output (“I/O”) devices/interfaces 1208, which are provided to allow a user to provide input to (such as user strokes), receive output from, and otherwise transfer data to and from the computing device 1200. These I/O devices/interfaces 1208 may include a mouse, keypad or a keyboard, a touch screen, camera, optical scanner, network interface, modem, other known I/O devices or a combination of such I/O devices/interfaces 1208.

The computing device 1200 can further include a communication interface 1210. The communication interface 1210 can include hardware, software, or both. The communication interface 1210 can provide one or more interfaces for communication (such as, for example, packet-based communication) between the computing device and one or more other computing devices (e.g., computing device 1200) or one or more networks. The computing device 1200 can further include a bus 1212. The bus 1212 can comprise hardware, software, or both that couples components of computing device 1200 to each other.

What is claimed is:

1. A computer-implemented method comprising:
generating, utilizing a large language model, an initial extractive summary of a digital document;
generating a feedback set comprising a set of annotations indicating corrections to the initial extractive summary relative to one or more coherent summaries of the digital document and a set of quality scores for the initial extractive summary; and
adjusting parameters of the large language model to reduce differences between the initial extractive summary and the one or more coherent summaries based on the feedback set.

2. The computer-implemented method of claim 1, wherein generating the initial extractive summary comprises:
extracting a set of sentences from the digital document by dividing the digital document at a sentence level; and
prompting the large language model to generate the initial extractive summary by selecting a subset of sentences from the set of sentences.

3. The computer-implemented method of claim 1, wherein generating the feedback set comprises:
generating one or more coherent summaries of the digital document based on inputs from one or more annotation sources; and
generating the set of annotations comprising natural language explanations indicating how to modify the initial extractive summary to obtain the one or more coherent summaries.

4. The computer-implemented method of claim 3, wherein generating the one or more coherent summaries of the digital document comprises utilizing an annotation source to:
select a set of sentences from the digital document indicating contextual and semantic summary content of the digital document; and
determine a coherent summary including summarized content of the digital document based on the set of sentences.

5. The computer-implemented method of claim 3, wherein generating the set of annotations comprises:
generating a comparison of the initial extractive summary and the one or more coherent summaries; and
generating a natural language explanation of converting the initial extractive summary to the one or more coherent summaries based on the comparison.

6. The computer-implemented method of claim 1, wherein generating the feedback set comprises:
generating a first quality score indicating a relevance of content in initial extractive summary in relation to the digital document;
generating a second quality score indicating a coherence of the initial extractive summary based on a structure and organization of content in the initial extractive summary; and
generating a third quality score indicating a consistency of the initial extractive summary relative to a plurality of sentences in the digital document.

7. The computer-implemented method of claim 1, further comprising generating, utilizing the large language model with the adjusted parameters, an additional extractive summary for an additional digital document.

8. The computer-implemented method of claim 1, wherein generating the feedback set comprises:
generating, utilizing a first machine-learning model, a first set of annotations indicating first corrections to the initial extractive summary relative to the one or more coherent summaries of the digital document; and
generating, utilizing a second machine-learning model, a second set of annotations indicating second corrections to the initial extractive summary relative to the one or more coherent summaries of the digital document.

9. A system comprising:
one or more memory devices; and
one or more servers configured to cause the system to:
generate, utilizing a large language model, an initial extractive summary of a digital document;
generate a feedback set comprising a set of annotations indicating corrections to the initial extractive summary relative to one or more coherent summaries of the digital document;
generate, utilizing the large language model and from the digital document, a predicted feedback set comprising a set of predicted annotations for the digital document; and
adjust parameters of the large language model to reduce differences between the feedback set and the predicted feedback set.

10. The system of claim 9, wherein the one or more servers are configured to generate the initial extractive summary of the digital document by prompting the large language model to select a set of sentences from the digital document and summarize the digital document based on the set of sentences.

11. The system of claim 9, wherein the one or more servers are configured to generate the feedback set by:
prompting a first machine-learning model to generate a first set of annotations indicating one or more differences between a set of sentences selected from the digital document by the large language model for generating the initial extractive summary and a first additional set of sentences used to generate the one or more coherent summaries; and
prompting a second machine-learning model to generate a second set of annotations indicating one or more differences between the set of sentences selected from the digital document by the large language model for generating the initial extractive summary and a second additional set of sentences used to generate the one or more coherent summaries.

12. The system of claim 9, wherein the one or more servers are configured to adjust parameters of the large language model by:
prompting the large language model with the digital document to generate the set of predicted annotations of the predicted feedback set;
determining a loss indicating the differences between the set of annotations of the feedback set and the set of predicted annotations of the predicted feedback set; and
adjusting the parameters of the large language model to reduce the differences based on the loss.

13. The system of claim 9, wherein the one or more servers are configured to generate, utilizing the large language model with the adjusted parameters, an additional extractive summary of the digital document.

14. The system of claim 9, wherein the one or more servers are configured to generate the feedback set comprising a set of quality scores indicating one or more of a relevance, a coherence, or a consistency of the initial extractive summary.

15. The system of claim 9, wherein the one or more servers are configured to generate the feedback set comprising a feedback instance including:
the digital document;
the initial extractive summary;
a natural language explanation for modifying the initial extractive summary to create a coherent summary of the one or more coherent summaries;
the coherent summary of the one or more coherent summaries; and
a set of quality scores for the initial extractive summary.

16. A non-transitory computer readable medium comprising instructions that, when executed by at least one processor, cause a computing device to perform operations comprising:
generating, utilizing a large language model, an initial extractive summary of a digital document utilizing a set of sentences extracted from the digital document to summarize the digital document;
generating a feedback set comprising:
a set of annotations indicating corrections to the initial extractive summary or the set of sentences extracted from the digital document;
one or more coherent summaries of the digital document; and
a set of quality scores indicating at least a coherence of the initial extractive summary; and
adjusting parameters of the large language model to reduce differences between the initial extractive summary and the one or more coherent summaries of the digital document based on the feedback set.

17. The non-transitory computer readable medium of claim 16, wherein generating the initial extractive summary of the digital document comprises:
dividing the digital document at a sentence level into a plurality of sentences; and
prompting the large language model to generate the initial extractive summary by:
selecting a subset of sentences from the plurality of sentences; and
generating the initial extractive summary based on the subset of sentences.

18. The non-transitory computer readable medium of claim 16, wherein generating the feedback set comprises determining the set of annotations comprising natural language explanations for modifying the initial extractive summary to obtain the one or more coherent summaries.

19. The non-transitory computer readable medium of claim 16, wherein adjusting the parameters of the large language model comprises generating, utilizing one or more machine-learning models:
the set of annotations indicating the corrections to the initial extractive summary or the set of sentences extracted from the digital document;
the one or more coherent summaries of the digital document; and
the set of quality scores indicating at least the coherence of the initial extractive summary.

20. The non-transitory computer readable medium of claim 17, wherein adjusting the parameters of the large language model comprises:
determining a loss indicating the differences between the initial extractive summary and the one or more coherent summaries by providing the digital document, the initial extractive summary, and the feedback set to the large language model; and
finetuning the parameters of the large language model to reduce the differences between the initial extractive summary and the one or more coherent summaries based on the loss.
